(19) United States
(12) Patent Application Publication
(10) Pub. No.: US 2025/0143453 A1
(43) Pub. Date: May 8, 2025

(54) COLLAPSIBLE ONE WIRE WORKSTATION

(71) Applicants: Mukul GUGLE, Pune (IN); Mayur HAJARE, Ahmednagar (IN)

(72) Inventors: Mayur HAJARE, Jamkhed (IN); Mukul GUGLE, Pune (IN)

(21) Appl. No.: 18/838,295

(22) PCT Filed: Feb. 17, 2023
(86) PCT No.: PCT/IN2023/050159

§ 371 Date: Aug. 14, 2024

(30) Foreign Application Priority Data
Feb. 17, 2022 (IN) 202221002190

(51) Int. Cl. A47B 21/06; A47B 3/08; A63F 13/90

(52) U.S. Cl. CPC A47B 21/06; A47B 3/08; A47B 2021/066; A47B 2200/0097; A63F 13/90

(57) ABSTRACT

A collapsible one wire workstation 100 is disclosed that includes a pair of opposed panels 104 and 108 that are horizontally collapsible, connectable and retractable along a horizontal axis that is parallel to the plane on which the workstation 100 is positioned. The workstation 100 includes a sliding assembly 150 for transforming the workstation 100 from a open configuration to a close configuration. The workstation 100 has two configurations such as a first closed configuration and a second opened configuration. The workstation 200 has a pair of opposed panels 202, 204 and a central panel 206. The workstation 200 includes an actuating assembly 215 for transforming the workstation from an open configuration to a close configuration.

### FIELD OF THE INVENTION

The present invention relates to workstations and more particularly collapsible workstations that are connectable to a plurality of electronic gadgets with a single wire.

### BACKGROUND OF THE INVENTION

Computer games and electronic gaming systems are largely followed trends by the modern generation. With the aid of digitalization, there is revolution in the gaming industry that has led to the development of interactive games and advanced gaming techniques. The gaming industry has flourished and has become a major economic sector and it caters to the needs of gamers, content creators, streamers and users in general; and professionals are involved in the coding and designing of these electronic gaming systems.

With the growing need of innovative computerised games, setups, workstations and game stations, the furniture is being designed so that the user gets the best experience of the game. The gamers and content creators demand workstations and furniture designed to specifically cater to the long gaming sessions, coding and designing. In one of such attempts to meet the need of gamers US Patent U.S. Pat. No. 7,908,978B1 to Pelton Jr Howard D teaches a computer gaming desk station that provides area for gaming accessories including joysticks, steering wheels, etc. The desktop has a central structure that provides space to accommodate large chair or a recliner.

The patent application GB Patent Application 2396295A to Heathcote Brian Sydney discloses a gaming furniture with support structure having an erectable and collapsible platform arrangement for multiple video game controllers.

In another U.S. Pat. No. 5,044,284 to Milton Gross describes a computer workstation for supporting and positioning a computer or video display terminal or screen and its keyboard. U.S. Pat. No. 5,044,284 facilitates elevation of display screen, keyboard shelf, arm rests, computer table through a pulley mechanism. A stop pin is provided through a hole in the table to lock the position of the table at desired inclination. Arm rests are pivotally mounted on the side walls to raise or lower the position of arm rests as per user's convenience.

The prior art generally teaches workstations and furniture that can accommodate the gaming accessories required for advanced gaming. But demand for specialised gaming set-up that is ergonomically designed especially for the purpose of getting the best gaming experience is not available to the users in the prior art. It is observed that computer gamers need, clutter-free; sleek, foldable, game setup.

There is a need of a gaming workstation that is operable through electronic devices. There is a need of a workstation that is collapsible and retractable that provides comfort to the users. Further, there is a need of a workstation and saves space by transforming the workstation when not in use.

### BRIEF DESCRIPTION OF THE DRAWINGS

The objectives and advantages of the present invention will become apparent from the following description read in accordance with the accompanying drawings wherein

FIG. 1 shows a front view of a collapsible single wire workstation in a closed configuration in accordance with a preferred embodiment of the present invention;

FIG. 2 shows a front view of a collapsible single wire workstation of FIG. 1 in an open configuration in accordance with a preferred embodiment of the present invention;

FIG. 3 shows a rear view of a collapsible single wire workstation of FIG. 1 in the open configuration in accordance with a preferred embodiment of the present invention;

FIG. 4 shows initial step of changing the configuration of the collapsible single wire workstation of FIG. 1 from close configuration to an open configuration;

FIG. 5 shows intermediate step of changing the configuration of the collapsible single wire workstation of FIG. 1 from close configuration to an open configuration;

FIG. 6 shows the collapsible single wire workstation of FIG. 1 in an open configuration;

FIG. 7, shows a schematic of the collapsible workstation of FIG. 1;

FIG. 8 shows a top view of another embodiment of a collapsible single wire workstation in close configuration accordance with the present invention;

FIG. 9, shows a front view of another embodiment of collapsible workstation in an open configuration of FIG. 8;

FIG. 10 shows an initial step involved in a preferred method of changing configuration of another embodiment from the first open configuration to the second close configuration of FIG. 8;

FIG. 11 shows intermediate steps involved in a preferred method of changing configuration of another embodiment from the first open configuration to the second close configuration of FIG. 8;

FIG. 12 shows intermediate steps involved in a preferred method of changing configuration of another embodiment from the first open configuration to the second close configuration of FIG. 8; and

FIG. 13 shows final step involved in a preferred method of changing configuration of another embodiment from the first open configuration to the second close configuration of FIG. 8.

### LIST OF NUMERALS

A pair of opposed panels 104, 108; a plurality of wheels 112; a base 113, 113A; a function panel 116; a power button 116a; a pre-set button 116b; a pair of navigation buttons 116c and 116d; a plurality of holders 120; a tabletop 124; a pocket 125; a swivel 132; a footrest 114; a storage unit 135; a pair of exhaust fans 138; a power socket 136; a sliding assembly 150; a carriage 152; a plurality of vertical tracks 154; a rack and pinon mechanism 156; a first pivot point 142; a second pivot point 144; a first hinge 146; a second hinge 148; an anchor assembly 157; a first anchor 158; a second anchor 159; a microcontroller 162; a communication module 164; a motor 166; an audio output device 168; a buzzer 170; a microphone 172; a mode controller 174; a processing chip 176; an electronic device 180; a first motor driver 178; a second motor driver 179; a power unit 182; a first side panel 202; a second side panel 204; a central panel 206; a function panel 208; a power button 208a, a pre-set button 208b; a pair of navigation buttons 208c, 208d; a storage shelf 210; a tabletop 212; an actuating assembly 215; an actuator 216; a first linkage 218; a second linkage 220; a third linkage 222; a first joint 224; and a second joint 226;

### SUMMARY OF THE INVENTION

A collapsible one wire workstation including a plurality of holders, a plurality of wheels, a display monitor, a pocket, a storage unit, a pair of exhaust fans and a power socket. An opposed pair of panels and horizontally collapsible and retractable along the direction as indicated by arrows ‘X’ and ‘X′’; a tabletop connecting the first side panel with the second side panel. The plurality of wheels securely mounted beneath a base. A swivel connecting the tabletop from first end and the display monitor from the second end; a function panel positioned on the side panel of the workstation.

The footrest being positioned parallel to the tabletop connecting the first side panel with the second side panel. A sliding assembly being positioned inside the side panel, the sliding assembly including a carriage for housing ball bearings, a plurality of vertical tracks, and a rack and pinon mechanism. The rack and pinion mechanism sliding on the plurality of vertical tracks and carriage to transform the workstation. A first pivot point and a second pivot point being mounted on the carriage, the first pivot point connecting the tabletop whereas the second pivot point connecting the footrest. A first hinge and a second hinge fixedly mounted on the side panel.

A microcontroller and a microphone positioned inside the side panels configured to recognize voice commands for transforming the workstation from an opening configuration to a close configuration. An anchor assembly lifting the side panel from the ground level. A first open configuration and a second closed configuration of the workstation wherein, said configurations are convertible from second configuration to first configuration and first configuration to second configuration.

The anchor assembly includes a first anchor and a second anchor driven in the direction as indicated by arrow ‘Z’ for lifting the side panel. The wheels moving the side panel away from the side panel in a direction along the X-axis while transitioning the workstation from the closed configuration to the open configuration and vice versa. The function panel includes a power button (not shown), a pre-set button (not shown) and a pair of navigation buttons and for operating the workstation. The swivel positions the monitor in three positions a first flat position onto the table in the direction as indicated by Arrow ‘C’, a second tilted position and a third open position.

The first pivot point and the second pivot point moving the tabletop and the footrest along the direction as indicated by arrow ‘D’. The first hinge and the second hinge inclining the tabletop and the footrest in the direction as indicated by arrow ‘B’. The collapsible one wire workstation as claimed in claim 1 wherein, the sliding assembly moving from an initial resting position to a locking position unless the second pivot point and the second hinge align in a same plane. The locking position of the tabletop the first pivot point and the first hinge are aligned in a same plane to lock the tabletop in the first pivot point. The locking position of the footrest, the second pivot point and the second hinge are aligned in a same plane to lock the footrest in the second pivot point.

A collapsible one wire workstation including a storage shelf comprising a first side panel and a second side panel being positioned bilaterally. A central panel connecting the side panel and the side panel from it's edges. A function panel positioned on side panel, a tabletop connecting the first side panel with the second side panel, a footrest being fixedly connected to the central panel and positioned exactly parallel and below the tabletop.

An actuating assembly transforming the configuration of the workstation, the actuating assembly including an actuator positioned inside the central panel, a first linkage positioned on the side panel and in close proximity to the actuator. A second linkage positioned on the side panel and in close proximity to the actuator, and a third linkage positioned on the central panel. A first joint connecting the side panel with the central panel from posterior end. A second joint connecting the side panel with the central panel from posterior end.

A first open configuration and a second closed configuration wherein, said configurations are convertible from second configuration to first configuration and first configuration to second configuration. The tabletop is fixedly connected with the central panel along the X-Axis. The third linkage connects the first linkage from one end and second linkage from another end. The actuating assembly moving the first linkage, the second linkage, the side panel and in a locking position. In the locking position, of the workstation, the side panel, the central panel and the side panel form a C-shape.

In a resting position of the workstation, the first linkage, the second linkage and the third linkage form U-shape. In the close configuration the first linkage and the third linkage form approximately 90° angle and the second linkage and the third linkage also form approximately 90° angle. The actuating assembly pushes the first linkage and the second linkage for transforming from first open configuration to second close configuration and pulls the linkages for transforming to the second close configuration from the first open configuration.

The function panel includes a power button (not shown), a pre-set button (not shown) and a pair of navigation buttons and for operating the workstation electro-mechanically. The actuating assembly driving the side panel away unless the side panels reach their locking position from the resting position.

### DETAILED DESCRIPTION OF THE DRAWINGS

The invention herein is described using specific exemplary details for better understanding. However, the invention disclosed can be worked on by a person skilled in the art without the use of these specific details.

References in the specification to “one embodiment” or “an embodiment” means that particular feature, structure, characteristic, or function described in connection with the embodiment is included in at least one embodiment of the invention. The appearances of the phrase “in one embodiment” in various places in the specifications are not necessarily all referring to the same embodiment.

References in the specification to “preferred embodiment” means that a particular feature, structure, characteristic, or function described in detail thereby omitting known constructions and functions for clear description of the present invention.

The present invention is illustrated with reference to the accompanying drawings, throughout which reference numbers indicate corresponding parts in the various figures.

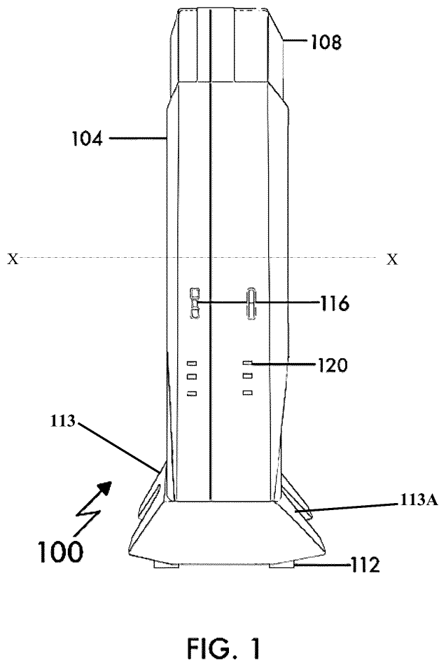

Referring to FIG. 1 a collapsible one wire workstation 100 in accordance with a preferred embodiment of the present invention is described. The collapsible one wire workstation 100, hereinafter referred as workstation 100 includes a pair of opposed panels 104 and 108 that are horizontally collapsible along axis-X. The pair of opposed panels 104 and 108 are preferably elongated shaped however, the design of the panels 104 and 108 varies in other embodiments of the present invention. In other embodiments of the present invention, users positions the CPU (Central Processing Unit), UPS (Uninterrupted Power Supply), compact printers and scanners inside the side panels 104 and 108.

The workstation 100 has two configurations such as a first closed configuration and a second open configuration. The opposed pair of panels 104 and 108 are connectable and retractable along the length of axis-X. The workstation 100 includes a plurality of wheels 112 for example caster wheels that are securely mounted beneath a base 113, 114 of the workstation 100 respectively. The wheels 112 move the panels 104 away from the side panel 108 in a direction along X-axis and while transitioning the workstation 100 from the closed configuration to the open configuration and vice versa. In context of the present invention, the panels 104 and 108 are preferably made of plastic material, glass/tempered. It is noted that. the panels 104, 108 may be made of any other materials such as mouldable materials, fibre, wood, aluminium, composites or the like in other embodiments of the present invention.

The workstation 100 advantageously includes only a single wire for connecting all the components inside the workstation 100 to the power point. The workstation 100 includes a function panel 116 that is accessed by a user to transform the workstation 100 from an open configuration to a closed configuration along the X-axis. The function panel 116 includes a power button 116a (not shown), a pre-set button 116b (not shown) and a pair of navigation buttons 116c and 116d (not shown).

The function panel 116 is positioned on the side panel 104 of the workstation 100. The power button 116a activates the power supply to the workstation 100. The pre-set button 116b is configured to change the aesthetic illumination of plurality of LED's 140 as per user's requirement. The pair of navigation buttons 116c and 116d open and close the panels 104 and 108 of the workstation 100. The workstation 100 also includes a plurality of holders 120 that receive elements such as hangers, hooks and the like.

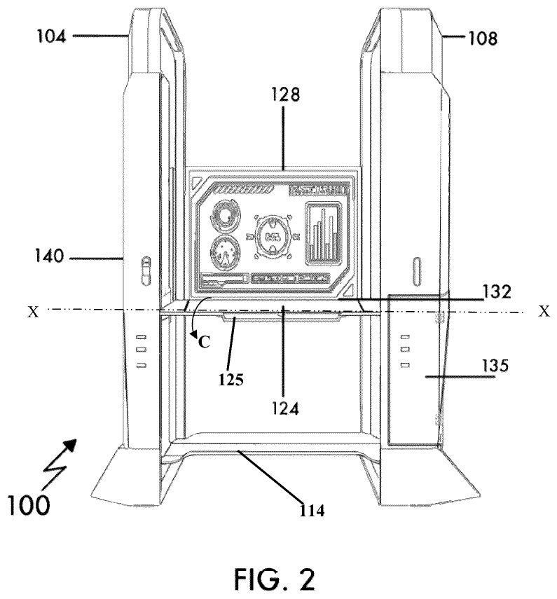

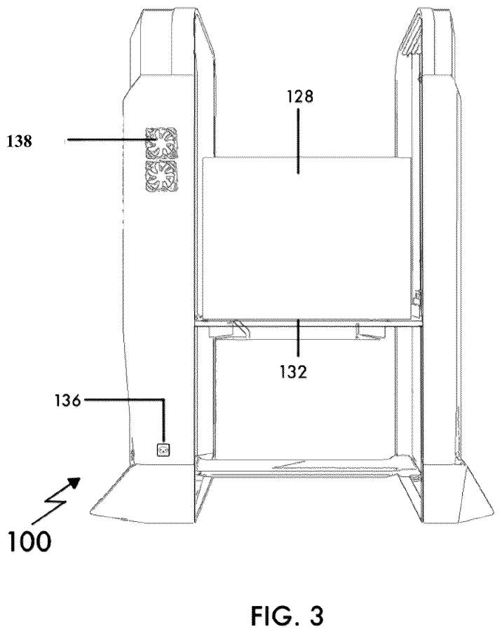

Now referring to FIGS. 2 and 3, the workstation 100 is described hereinafter. The workstation 100 includes a tabletop 124 that connects the first side panel 104 with the second side panel 108. The tabletop 124 includes a pocket 125 for placing keyboard, mouse or the like. The pocket 125 is positioned beneath the tabletop 124 along the X-Axis.

The workstation 100 includes a display monitor 128 that is removably connected with the tabletop 124 through a swivel 132. The swivel 132 joins tabletop 124 from one side and the display monitor 128 from the other side however, the type of swivel varies in other embodiments of the present invention. The swivel 132 positions the monitor in three positions i.e. a first folded position, a second tilted position and a third open position as per the user comfort. In a first folded position, the swivel 132, positions the display monitor 128 to be folded flat onto the table 124 in the direction as indicated by Arrow ‘C’ when not in use through a swivel motion. In a second tilted position, the swivel 132, tilts the display monitor 128 in about 35° whereas in the third open position, the display monitor 128 is in a usable state forming 90° angle with the tabletop 124.

The swivel 132 flexibly moves the display monitor 128 from an open configuration to a close configuration. In an open configuration, the display monitor 128 is perpendicular to the tabletop 124. Contrarily, in a close configuration the display monitor 128 is parallel to the tabletop 124. The swivel 132 is designed to support screen sizes of different weight and dimensional compatibility.

The workstation 100 also includes a footrest 114. In an open configuration of the workstation 100 the footrest 114 is positioned parallel to the tabletop 124 connecting the side panels 104 and 108 from both ends. The footrest 114 is positioned exactly below and parallel to the tabletop 124. The workstation 100 includes a storage unit 135 positioned in the side panel 108. The storage unit 135 is positioned at the lower end of the side panel 108. The storage unit 135 is approximately 762 mm×270 mm×760 mm [L×B×H]. The storage unit 135 snap fits in the side panel 108 with compartments internally divided according to possible usability of that space. Each of the opposed panel 104 and 108 includes plurality of LED lights 140 (not seen) embedded therein. The plurality of LEDs 140 is also positioned on the outer surface of each of opposed panels 104 and 108. for example, RGB led lights or the like.

The workstation also includes a pair of exhaust fans 138 that are positioned on the side panel 108. The exhaust fans 138 are preferably positioned on the rear side of the side panels 108. The exhaust fans 138 outlet heat from the workstation 100. The workstation 100 also include a power socket 136 positioned behind the side panel 108 and along the length of exhaust fans 138. The power socket 136 is connected with the power plug to inlet power supply to the workstation 100.

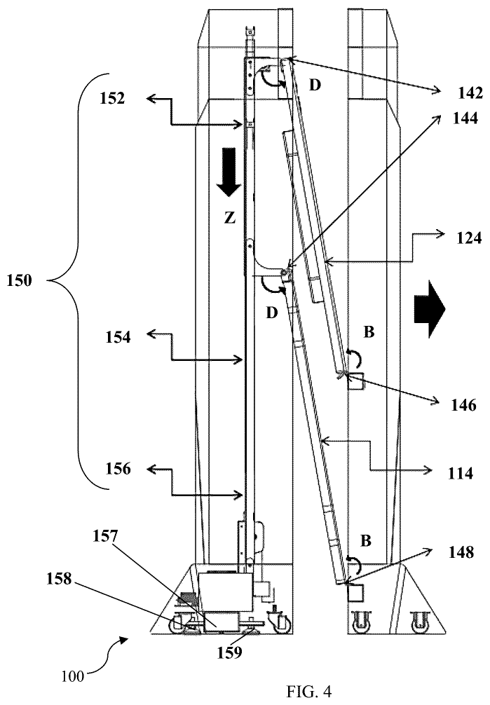

Now referring to FIG. 4, the workstation is described. The workstation 100 includes a sliding assembly 150 that is positioned inside the side panel 108. The sliding assembly 150 includes a carriage 152, a plurality of vertical tracks 154 and a rack and pinon mechanism 156. The carriage 152 is a housing for ball bearings and a plurality of vertical tracks 154. The vertical tracks 154 house a rack and pinion mechanism 156. The rack and pinion mechanism 156 slides on the plurality of vertical tracks 154 and carriage 152 while transforming the workstation 100 from a close configuration to an open configuration and vice versa.

The workstation 100 includes a first pivot point 142 and a second pivot point 144. The first pivot point 142 and the second pivot point 144 are mounted on the carriage 152. The first pivot point 142 connects with the tabletop 124 whereas the second pivot point 144 connects with the footrest 114 respectively. The first pivot point 142 and the second pivot point 144 move the tabletop 124 and the footrest 114 along the direction as indicated by arrow ‘D’.

The workstation 100 also includes a first hinge 146 and a second hinge 148 fixedly mounted on the side panel 104. The first hinge 146 connects with the tabletop 124 whereas the second hinge 148 connects with the footrest 114 respectively. The first hinge 146 and the second hinge 148 facilitates harmonised movement of tabletop 124 and footrest 114 about the hinges 146 and 148 respectively. The first hinge 146 and the second hinge 148 moves the tabletop 124 and footrest 114 as indicated by arrow ‘B’.

The first pivot point 142, the second pivot point 144, the first hinge 146 and the second hinge 148 are seen in an initial resting position. In the close configuration of the workstation 100, the first pivot point 142, the second pivot point 144, the first hinge 146 and the second hinge 148 are in an initial resting position. Similarly, the tabletop 124 and the footrest 114 are in an initial folded position.

The workstation 100 includes an anchor assembly 157 positioned inside the side panel 108. The anchor assembly 157 is positioned proximal to the plurality of wheels 112 for lifting the side panel 108 by approximately 2-3 inches from ground level. The anchor assembly 157 includes a first anchor 158 and a second anchor 159. The anchor assembly 157 hydraulically powers the first anchor 158 and the second anchor 159. The anchor assembly 157 pushes the first anchor 158 and the second anchor 159 in the direction as indicated by arrow ‘Z’. Further, the anchor assembly 157 lifts the side panel 108 by approximately 2-3 inches from the ground level.

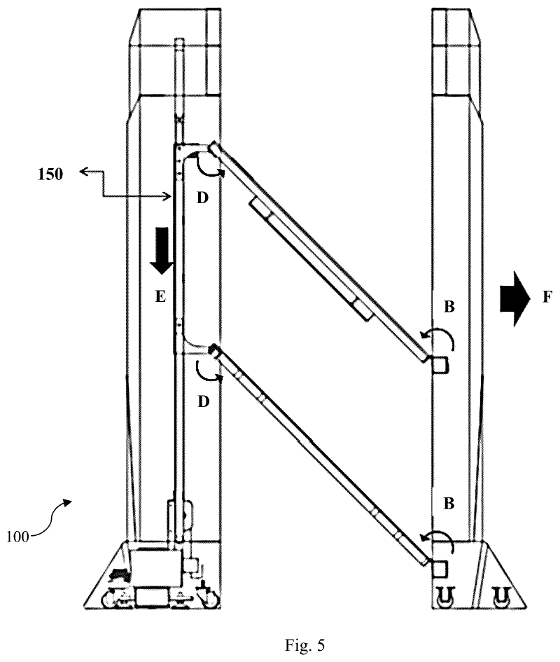

Now referring to FIG. 5, the user accesses the power button 116a to transit the state of the workstation 100 from a close configuration to an open configuration. The sliding assembly 150 is driven in the direction as indicated by arrow ‘E’. Accordingly, the movement of sliding assembly 150 moves the first pivot point 142, the second pivot point 144, in the direction as indicated by arrow ‘E’.

The movement of the first pivot point 142 and the second pivot point 144 descends the tabletop 124 and the footrest 114 from their initial position in the direction as indicated by arrow ‘E’. Simultaneously, the descending of the tabletop 124 and the footrest 114 pushes away the side panel 104 in an opposite direction from the side panel 108 as indicated by arrow ‘F’. The first hinge 146 and the second hinge 148 inclines the connected tabletop 124 and the footrest 114 in the direction as indicated by arrow ‘B’.

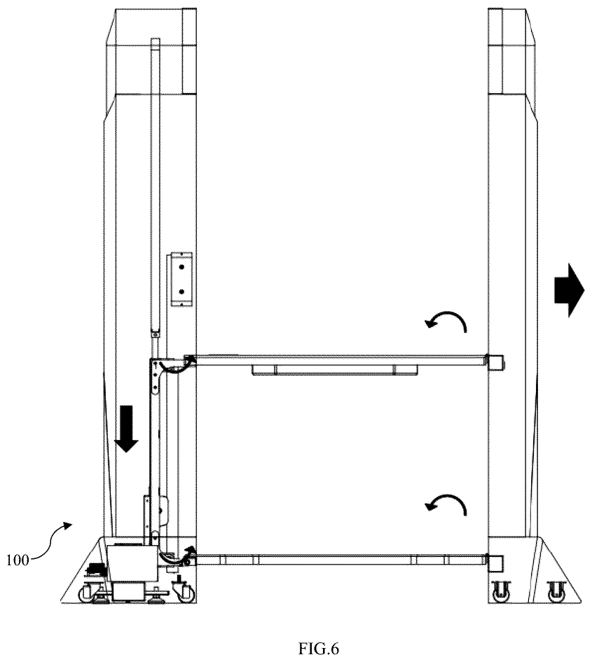

Referring to FIG. 6, the transformation of the workstation 100 from an close configuration to an open configuration is described. The sliding assembly 150 moves along the direction as indicated by arrow ‘E’ unless the first pivot point 142 and the first hinge 146 align in a same plane. Similarly, the sliding assembly 150 moves along the direction as indicated by arrow ‘E’ unless the second pivot point 142 and the second hinge 146 align in a same plane. Accordingly, the tabletop 124 and the footrest 114 are moved continuously from an initial position to the locking position.

In accordance with the present invention, in the locking position of the tabletop 124 the first pivot point 142 and the first hinge 146 are aligned in a same plane to lock the tabletop 124 in the first pivot point 142. Accordingly, in the locking position of the footrest 114, the second pivot point 144 and the second hinge 148 are aligned in a same plane to lock the footrest 114 in the second pivot point 144.

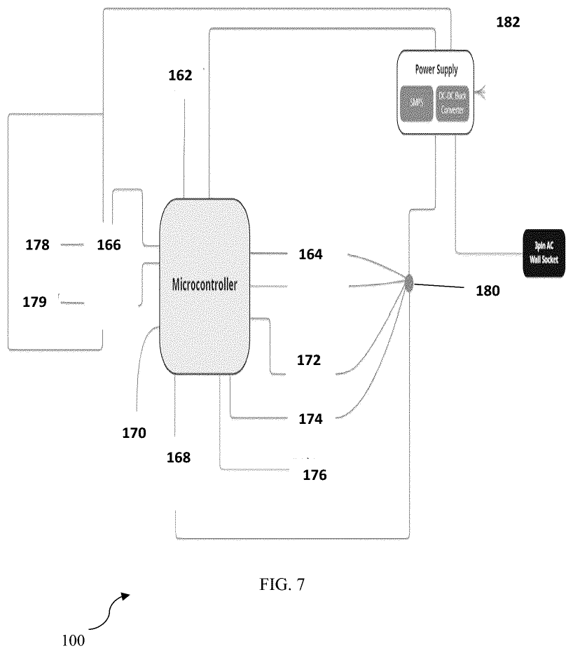

Referring to FIGS. 1 and 7, the control panel 160 of the workstation 100 is described. The workstation includes a microcontroller 162, a communication module 164, a motor 166, an audio output device 168 and an audio indicator for example a buzzer 170. The workstation further includes a microphone 172 and a mode controller 174.

The microcontroller 162 receives user inputs through a microphone 172 or through a function panel 116. The microcontroller 162 is configured to recognize voice commands for transforming the workstation 100 from an opening configuration to a close configuration and vice versa. The microcontroller 162 processes the user inputs by processing the commands on a processing chip 176. The microcontroller 162 activates the motor 166 and LED lights 140 as per user instructions.

The communication module 164 wirelessly connects the workstations 100 with an electronic device 180. In this preferred embodiment, the communication module 164 establishes wireless communication with the electronic device 180 through NFC (Near Field Communication), Bluetooth, Wi-Fi, Zigbee and the like, however, communication medium varies in other embodiments of the present invention. In accordance with the present invention, the user connects with the workstation 100 through the electronic device 180 for example a handheld device. The user controls the illumination of LEDs through various colour combinations present on the electronic device 180.

The motor 166 include a first motor driver 178, a second motor driver 179. The motor 166 drives the sliding assembly 150 and a rack and pinion mechanism 156 to transform the workstation 100 from an open configuration to a close configuration and vice versa. The first motor driver 178 is configured to drive a first motor whereas the second motor driver 179 is configured to operate an anchor motor.

The microcontroller 162 activates the buzzer 170 to indicate the changing configuration of the workstation 100. The audio output device 168 includes an amplifier, speaker that are activated by a microcontroller 162 upon receiving user instructions. The plurality of LEDs 140 are configured to illuminate as per user's instructions. For example, the LEDs 140 illuminate in a different pattern when user selects gaming pre-set mode and in a working pre-set mode. The plurality of LEDs 140 synchronizes and illuminate as per the audio content played through audio output device 168.

The mode controller 174 is configured to selectively activate the mode pre-set as per the instructions received from the pre-set mode button 116b in the workstation 100. The workstation 100 also includes a power unit 182 that includes an SMPS (not shown) and DC to DC buck converter (not shown). The power unit 182 stabilizes the AC current received through the power socket 136 through an SMPS and DC to DC buck converter and supplies uniform power supply to the workstation 100.

The workstation 100 includes a plurality of sensors 184 (not seen). The sensors 184 are positioned inside the side panel 108, in the present invention the sensors 184 are ultrasonic sensors and line sensors however, the type of sensors varies in other embodiments of the present invention. The sensors 184 check obstacle in the direction of opening the workstation 100 as indicated by arrow ‘F’ in FIG. 5 of the present invention. The sensors 184 communicate with the microcontroller 162 in case of any obstacles while opening the panel 108. Accordingly, the microcontroller 162 is configured to prevent the workstation 100 from opening when the sensors 184 detect obstacle while opening the side panel 108.

In accordance with the present invention, the sensors 184 are also positioned on the inner side of the side panel 108. The sensors 184 check obstacle in the direction of closing the workstation 100 as indicated by arrow ‘B’ in FIG. 5 of the present invention. The sensors 184 communicate with the microcontroller 162 in case of any obstacles while opening the panel 108. Accordingly, the microcontroller 162 is configured to prevent the workstation 100 from opening when the sensors 184 detect obstacle while opening the side panel 108.

Referring to FIGS. 4 to 8, the steps involved in changing the configuration of the workstation 100 from a close configuration to an open configuration and vice versa are described. In an initial step, the sliding assembly 150 is activated to drive the first pivot point 142 and the second pivot point 144, in the direction as indicated by arrow ‘E’. Simultaneously, the movement of the first pivot point 142 and the second pivot point 144 descends the tabletop 124 and the footrest 114 from their initial resting position in the direction as indicated by arrow ‘E’.

Simultaneously, the descending of the tabletop 124 and the footrest 114 pushes away the side panel 104 in an opposite direction from the side panel 108 as indicated by arrow ‘F’. In a next step, the first hinge 146 and the second hinge 148 inclines the connected tabletop 124 and the footrest 114 respectively, in the direction as indicated by arrow ‘B’. In a next step, the sliding assembly 150 moves along the direction as indicated by arrow ‘E’ unless the first pivot point 142 and the first hinge 146 align in a same plane. Concurrently, the sliding assembly 150 moves along the direction as indicated by arrow ‘E’ unless the second pivot point 142 and the second hinge 146 align in a same plane. In a final step, the tabletop 124 and the footrest 114 are locked in their respective first pivot point 142 and the second pivot point 142.

In accordance with the present invention, by reversing the above-mentioned steps a user is able change the configuration of the workstation 100 from open configuration to close configuration. In accordance with the present invention, the display monitor 128 is folded on the tabletop 124 while transforming the workstation 100 from an open configuration to a close configuration and vice versa. While closing the side panels 104 and 108, the tabletop 124 aligns in one corner with the vertical side panel 108 and pulls the other panel 104 to slide inwards.

Referring to FIGS. 1 to 8, in operation, the user connects the power socket 136 with the power plug and activates power supply to the workstation 100. The user accesses the power button 116a or commands through the microphone 172 to transform the workstation 100 from a close configuration to an open configuration and vice versa. In a close configuration, the sliding assembly 150, the tabletop 124 and the footrest 114 are in an initial resting position. The power button 116a instructs the microcontroller 162 to activate the motor 166.

The motor 166 drives the sliding assembly 150 through the first motor driver 178 and the second motor driver 179. The sliding assembly 150 drives the first pivot point 142 and the connecting tabletop 124 from an initial resting position towards the locking position of the tabletop 124. Accordingly, the sliding assembly 150 drives the second pivot point 144 and the connecting footrest 114 from an initial resting position towards the locking position of the footrest 114. Accordingly, the microcontroller 162 activates the anchor assembly 157 and lifts up the side panel 108 while transforming the workstation 100 from close configuration to open configuration.

Simultaneously, the movement of sliding assembly 150 drives the side panel 104 away from the side panel 108 unless the tabletop 124 and the footrest 114 reaches to the locking position from the resting position. Further, the tabletop 124 and the footrest 114 lock into the pivot points 142 and 144 after reaching respective locking positions. Further, the user accesses the display monitor 128 and folds and unfolds onto the tabletop 124 as per the requirement through the swivel 132. The user then accesses the pre-set button 116b, to choose the preferred mode of illuminating LEDs 140. It is to be understood that in another embodiment of the workstation 100 a personal computer, laptop, tab or any electronic device is integrated with a side panel 108 and positioned in close proximity with exhaust fan positioned over the vents.

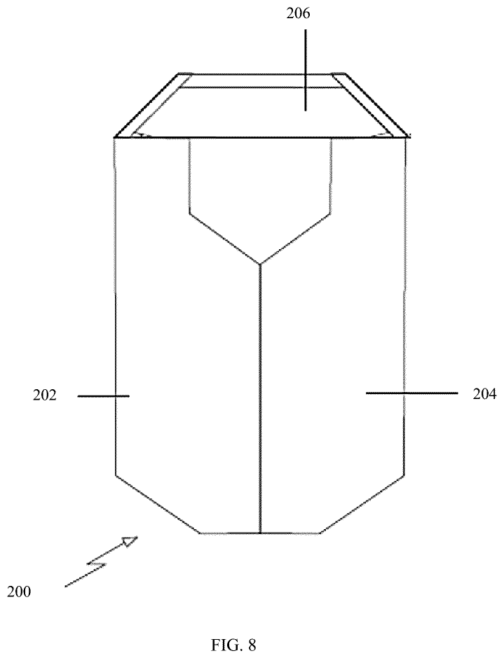

Now referring to FIG. 8 another embodiment 200 of the workstation 100 is shown. The workstation 200 includes a pair of opposed side panels i.e. a first side panel 202 and a second side panel 204. The opposed pair of side panels 202 and 204 are bilateral. The form factor of the opposed pair of side panels 202 and 204 is identical to one another. The workstation 200 includes a central panel 206 that connects the side panel 202 and the side panel 204 from it's edges. The central panel 206 is preferably square shaped however, the size and shape of the central panel 206 varies in other embodiments of the present invention. The workstation 200 has a first open configuration and a second close configuration. The workstation 200 opens and closes side panels 202 and 204 while transitioning from open configuration to close configuration.

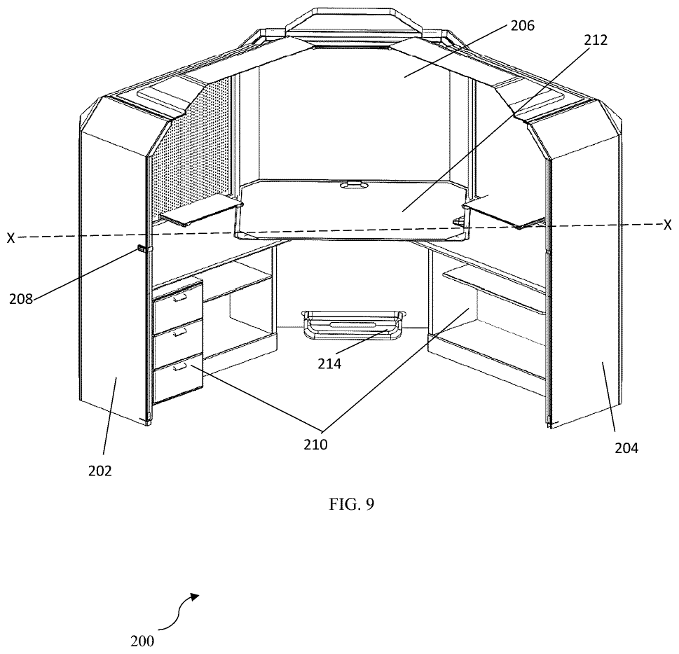

Referring to FIG. 9, the workstation 200 is described. The opposed pair of panels 202 and 204 are connectable and retractable along the length of X-axis. The workstation 200 includes a plurality of wheels (not seen) for example caster wheels that are securely mounted beneath a base (not seen) of the workstation 200 respectively. The wheels move the panels 202 and 204 in an opposite direction along X-axis while transitioning the workstation 200 from the closed configuration to the open configuration and vice versa. The panels 202 and 204 are preferably made of plastic material, glass/tempered. The panels 202, 204 may be made of any other materials such as mouldable materials, fibre, wood, aluminium, composites or the like in other embodiments of the present invention.

The workstation 200 has only a single wire for connecting all the components inside the workstation 200 to the power point. The workstation 200 includes a function panel 208 that is accessed by a user to transform the workstation 200 from an open configuration to a closed configuration along the X-axis. The function panel 208 includes a power button 208a (not shown), a pre-set button 208b (not shown) and a pair of navigation buttons 208c and 208d (not shown).

The function panel 208 is positioned on the side panel 202 of the workstation 100. The power button 208a activates the power supply to the workstation 100. The pre-set button 208b is configured to change the aesthetic illumination of plurality of LED's 240 as per user's requirement. The pair of navigation buttons 208c and 208d open and close the panels 202 and 204 of the workstation 200. The workstation 200 also includes a storage shelf 210 that receive elements such as hangers, hooks and the like.

The storage shelf 210 includes drawers that are provided inside the side panel 208. In context of the present invention, the storage shelves 210 are preferably of dimension 1200 mm×700 mm×600 mm (L×H×B) however, the form factor of storage shelves varies in other embodiments of the present invention. The storage shelves 210 are provided under both the side panels 202 and 204. The storage shelves 210 are used to store different devices, gadgets, stationery and the like.

The workstation 200 includes a tabletop 212 that connects the first side panel 202 with the second side panel 204. The tabletop 212 is fixedly connected with the central panel 206 along the X-Axis. The tabletop 212 is positioned perpendicular to the central panel 206. The workstation 200 also includes a footrest 214 that is fixedly connected to the central panel 206 and positioned exactly parallel and below the tabletop 212.

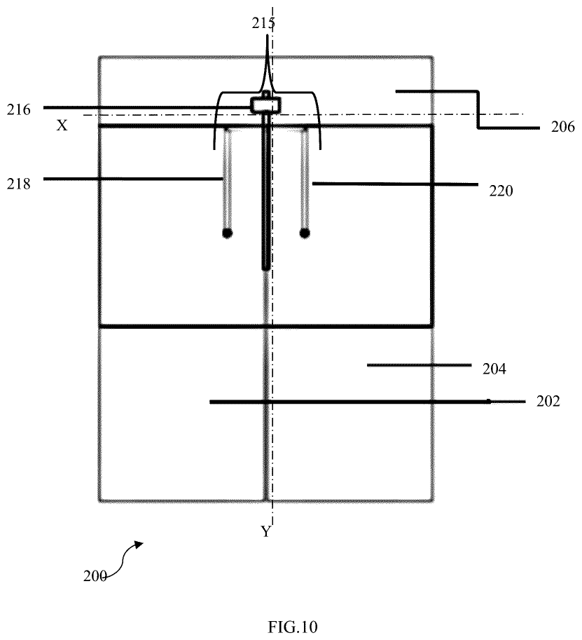

Referring to FIG. 10 the close configuration of the workstation 200 is described. The workstation 200 includes an actuating assembly 215 for transitioning the workstation 200 from open configuration to close configuration and vice versa. The actuating assembly 215 includes an actuator 216 that is driven through electrical and mechanical energy. The actuator 216 is positioned inside the central panel 206. The actuator 216 is positioned perpendicular to the side panels 202 and 204 and at the intersection of X-axis and Y-axis. In the present invention, the actuator 216 is preferably a Linear actuator however the type of actuators varies in other embodiments of the present invention.

The actuating assembly 215 includes a first linkage 218 positioned on the side panel 202 and in close proximity to the actuator 216. The actuating assembly 215 includes a second linkage 220 positioned on the side panel 204 and in close proximity to the actuator 216. The first linkage 218 and the second linkage 220 are positioned bilateral to one another in close configuration of the workstation 200. In accordance with the present invention, the actuating assembly 215 and the side panel 202 and 204 are seen in an initial resting position. In a resting position of the workstation 200, the first linkage 218, the second linkage 220 and the third linkage 222 form U-shape. The actuator 216 exerts a mechanical force to move a first linkage 218, a second linkage 220 and a third linkage 222.

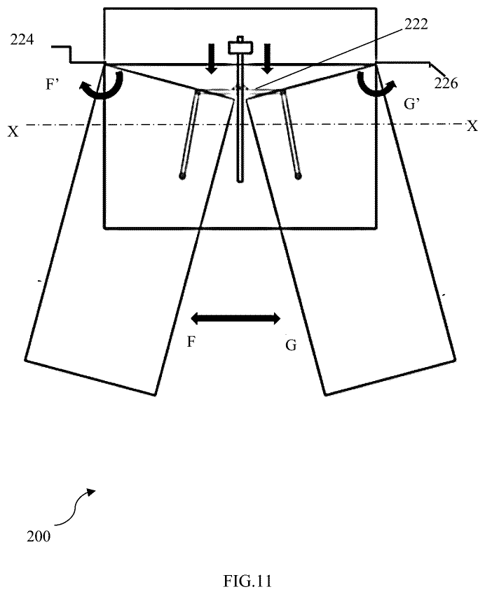

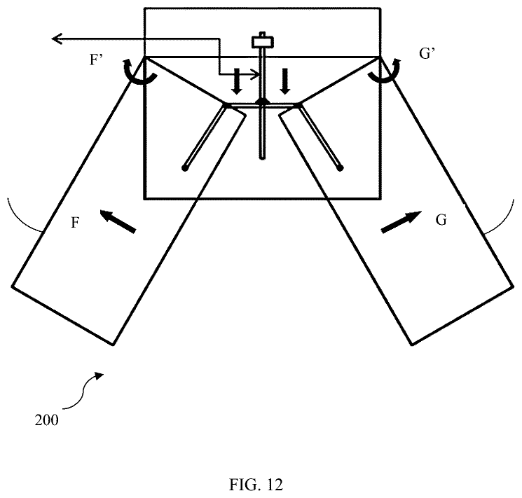

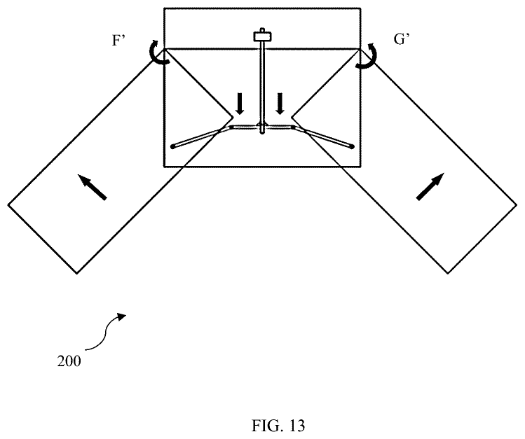

Referring to FIGS. 11-13, the workstation 200 is described. The actuating assembly 215 includes a third linkage 222 that is positioned on the central panel 206. The third linkage 222 connects the first linkage 218 from one end and second linkage 220 from another end. The third linkage 222 is fixedly connected to the central panel 206 along the length of X-Axis. The first linkage 218 connects to the side panel 202 from a first end and the third linkage 222 from another end. Similarly, the second linkage 220 connects to the side panel 204 from a first end and the third linkage 222 from another end. In accordance with the present invention, the actuating assembly 215 moves the first linkage 218, the second linkage 220, the side panel 202 and 204 in a locking position. In this locking position, of the workstation 200, the side panel 202, the central panel 206 and the side panel 204 form a C-shape.

In accordance with the present invention, the workstation 200 includes a first joint 224 and a second joint 226. The first joint 224 connects the side panel 202 with the central panel 206 from posterior end. Similarly, the second joint 226 connects the side panel 204 with the central panel 206 from posterior end. The first joint 224 enables the movement of side panel 202 in direction as indicated by arrows ‘F’ to ‘F′’ and vice versa. Similarly, the second joint 226 enables the movement of side panel 204 in direction as indicated by arrows ‘G’ to ‘G′’ and vice versa.

In a close configuration the first linkage 218 and the third linkage 222 form approximately 90° angle. Similarly, the second linkage 220 and the third linkage 222 form approximately 90° angle in a close configuration of the workstation 200. The workstation 200 activates, the actuating assembly 215 pushes the first linkage 218 and the second linkage 220 in the direction as indicated by arrows ‘F’ to ‘F′’ and ‘G’ to ‘G′’ respectively for transforming to open configuration from close configuration. Contrarily, the workstation 200 activates, the actuating assembly 215 to pull the first linkage 218 and the second linkage 220 in the direction as indicated by arrows ‘F′’ to ‘F’ and ‘G′’ to ‘G’ respectively for transforming to close configuration from open configuration.

Referring to FIGS. 10-13, the steps involved in changing the configuration of the workstation 200 from a close configuration to an open configuration and vice versa are described. In an initial step, the actuator 216 activates the first linkage 218 and the second linkage 220 to transform the configuration of the workstation 200 from open configuration to close configuration. In a next step, the actuator 216 moves the first linkage 218 in the direction as indicated by arrows ‘F’ and ‘F′’ to transform the configuration of the workstation 200 from close configuration to open configuration. Simultaneously, the actuator 216 moves the second linkage 220 in the direction as indicated by arrows ‘G’ and ‘G′’ to transform the configuration of the workstation 200 from close configuration to open configuration.

In this step, an open configuration, the first linkage 218 and the third linkage 222 form approximately 150° angle. Similarly, the second linkage 220 and the third linkage 222 form approximately 150° angle in an open configuration of the workstation 200. In accordance with the present invention, by reversing the above-mentioned steps a user is able change the configuration of the workstation 200 from open configuration to close configuration.

Referring to FIGS. 8 to 13, in operation, the user connects the power socket with the power plug and activates power supply to the workstation 200. The user accesses the power button 208a to transform the workstation 200 from a close configuration to an open configuration and vice versa. In a close configuration, the actuating assembly 215, the side panel 202 and 205 are seen in an initial resting position. The power button 208a instructs the microcontroller to activate the actuating assembly 215.

The actuating assembly 215 drives the first linkage 218 and the second linkage 220. The actuating assembly 215 drives the first linkage 218 and the second linkage 220 from an initial resting position towards the locking position of the side panel 202 and 204. Accordingly, the actuating assembly 215 drives the first linkage 218, the second linkage 220, the side panels 202 and 204 from an initial resting position towards the locking position.

Simultaneously, the movement of actuating assembly 215 drives the side panel 202, 204 away from the actuating assembly 215 unless the side panels 202, 205 reaches the locking position from the resting position. The user then accesses the pre-set button 208b, to choose the preferred mode of illuminating LEDs 140.

The workstation 100 of the present invention is advantageously usable as smart furniture for gamers, graphics designers, animation developers that gives the best gaming experience for the users. The workstation 100 advantageously, saves space because of collapsibility from the open configuration to close and vice versa. The workstation 100 advantageously has features such as voice recognition, mode changing ability. The workstation 100 is multifunctional, convertible and moveable as and when required and connects with multiple devices is switched when required.

The foregoing description of specific embodiments of the present invention has been presented for purposes of illustration and description. They are not intended to be exhaustive or to limit the present invention to the precise forms disclosed, and obviously many modifications and variations are possible in light of the above teaching.

The embodiments were chosen and described in order to best explain the principles of the present invention and its practical application, to thereby enable others, skilled in the art to best utilize the present invention and various embodiments with various modifications as are suited to the particular use contemplated.

It is understood that various omission and substitutions of equivalents are contemplated as circumstance may suggest or render expedient, but such are intended to cover the application or implementation without departing from the scope of the present invention.

1. A collapsible one wire workstation 100 including a plurality of holders 120, a plurality of wheels 112, a display monitor 128, a pocket 125, a storage unit 135, a pair of exhaust fans 138 and a power socket 136 characterized in that said workstation 100 comprising:
an opposed pair of panels 104 and 108 horizontally collapsible and retractable along the direction as indicated by arrows ‘X’ and ‘X′’; a tabletop 124 connecting the first side panel 104 with the second side panel 108; the plurality of wheels 112 securely mounted beneath a base 113, 113A;
a swivel 132 connecting the tabletop 124 from first end and the display monitor 128 from the second end; a function panel 116 positioned on the side panel 104 of the workstation 100; the footrest 114 being positioned parallel to the tabletop 124 connecting the first side panel 104 with the second side panel 108;
a sliding assembly 150 being positioned inside the side panel 108; the sliding assembly 150 including a carriage 152 for housing ball bearings, a plurality of vertical tracks 154, and a rack and pinon mechanism 156; the rack and pinion mechanism 156 sliding on the plurality of vertical tracks 154 and carriage 152 to transform the workstation 100;
a first pivot point 142 and a second pivot point 144 being mounted on the carriage 152; the first pivot point 142 connecting the tabletop 124 whereas the second pivot point 144 connecting the footrest 114; a first hinge 146 and a second hinge 148 fixedly mounted on the side panel 104;
a microcontroller 162 and a microphone 172 positioned inside the side panels 104 configured to recognize voice commands for transforming the workstation 100 from an opening configuration to a close configuration; an anchor assembly 157 lifting the side panel 108 from the ground level; and
a first open configuration and a second closed configuration of the workstation 100 wherein, said configurations are convertible from second configuration to first configuration and first configuration to second configuration.

2. The collapsible one wire workstation 100 as claimed in claim 1 wherein, the anchor assembly 157 includes a first anchor 158 and a second anchor 159 driven in the direction as indicated by arrow ‘Z’ for lifting the side panel 108.

3. The collapsible one wire workstation 100 as claimed in claim 1 wherein, the wheels 112 moving the side panel 104 away from the side panel 108 in a direction along the X-axis while transitioning the workstation 100 from the closed configuration to the open configuration and vice versa.

4. The collapsible one wire workstation 100 as claimed in claim 1 wherein, the function panel 116 includes a power button 116a (not shown), a pre-set button 116b (not shown) and a pair of navigation buttons 116c and 116d for operating the workstation 100.

5. The collapsible one wire workstation 100 as claimed in claim 1 wherein, the swivel 132 positions the monitor 128 in three positions a first flat position onto the table 124 in the direction as indicated by Arrow ‘C’, a second tilted position and a third open position.

6. The collapsible one wire workstation 100 as claimed in claim 1 wherein, the first pivot point 142 and the second pivot point 144 moving the tabletop 124 and the footrest 114 along the direction as indicated by arrow ‘D’

7. The collapsible one wire workstation 100 as claimed in claim 1 wherein, the first hinge 146 and the second hinge 148 inclining the tabletop 124 and the footrest 114 in the direction as indicated by arrow ‘B’.

8. The collapsible one wire workstation 100 as claimed in claim 1 wherein, the sliding assembly 150 moving from an initial resting position to a locking position unless the second pivot point 142 and the second hinge 146 align in a same plane.

9. The collapsible one wire workstation 100 as claimed in claim 1 wherein, in the locking position of the tabletop 124 the first pivot point 142 and the first hinge 146 are aligned in a same plane to lock the tabletop 124 in the first pivot point 142.

10. The collapsible one wire workstation 100 as claimed in claim 1 wherein, in the locking position of the footrest 114, the second pivot point 144 and the second hinge 148 are aligned in a same plane to lock the footrest 114 in the second pivot point 144.

11. A collapsible one wire workstation 200 including a storage shelf 210 characterized in that said workstation 200 comprising:
a first side panel 202 and a second side panel 204 being positioned bilaterally; a central panel 206 connecting the side panel 202 and the side panel 204 from it's edges; a function panel 208 positioned on side panel 202;
a tabletop 212 connecting the first side panel 202 with the second side panel 204, a footrest 214 being fixedly connected to the central panel 206 and positioned exactly parallel and below the tabletop 212;
an actuating assembly 215 transforming the configuration of the workstation 200; the actuating assembly 215 including an actuator 216 positioned inside the central panel 206, a first linkage 218 positioned on the side panel 202 and in close proximity to the actuator 216, a second linkage 220 positioned on the side panel 204 and in close proximity to the actuator 216, and a third linkage 222 positioned on the central panel 206;
a first joint 224 connecting the side panel 202 with the central panel 206 from posterior end; a second joint 226 connecting the side panel 204 with the central panel 206 from posterior end; and
a first open configuration and a second closed configuration wherein, said configurations are convertible from second configuration to first configuration and first configuration to second configuration.

12. The collapsible one wire workstation 200 as claimed in claim 11 wherein, the tabletop 212 is fixedly connected with the central panel 206 along the X-Axis.

13. The collapsible one wire workstation 200 as claimed in claim 11 wherein the third linkage 222 connects the first linkage 218 from one end and second linkage 220 from another end.

14. The collapsible one wire workstation 200 as claimed in claim 11 wherein, the actuating assembly 215 moving the first linkage 218, the second linkage 220, the side panel 202 and 204 in a locking position.

15. The collapsible one wire workstation 200 as claimed in claim 11 wherein, in the locking position, of the workstation 200, the side panel 202, the central panel 206 and the side panel 204 form a C-shape.

16. The collapsible one wire workstation 200 as claimed in claim 11 wherein, in a resting position of the workstation 200, the first linkage 218, the second linkage 220 and the third linkage 222 form U-shape.

17. The collapsible one wire workstation 200 as claimed in claim 11 wherein, in a close configuration the first linkage 218 and the third linkage 222 form approximately 90° angle and the second linkage 220 and the third linkage 222 also form approximately 90° angle.

18. The collapsible one wire workstation 200 as claimed in claim 11 wherein, the actuating assembly 215 pushes the first linkage 218 and the second linkage 220 for transforming from first open configuration to second close configuration and pulls the linkages 218 and 220 for transforming to the second close configuration from the first open configuration.

19. The collapsible one wire workstation 200 as claimed in claim 11 wherein, the function panel 208 includes a power button 208a (not shown), a pre-set button 208b (not shown) and a pair of navigation buttons 208c and 208d for operating the workstation 200 electro-mechanically.

20. The collapsible one wire workstation 200 as claimed in claim 11 wherein, the actuating assembly 215 driving the side panel 202, 204 away unless the side panels 202, 205 reach their locking position from the resting position.
